(19) United States
(12) Patent Application Publication
(10) Pub. No.: US 2016/0363881 A1
(43) Pub. Date: Dec. 15, 2016

(54) ELECTRO-CONDUCTIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Shohei Urushihara, Suntou-gun (JP); Hideya Arimura, Suntou-gun (JP)

(21) Appl. No.: 15/170,427

(22) Filed: Jun. 1, 2016

(30) Foreign Application Priority Data
Jun. 12, 2015 (JP) 2015-119285

(51) Int. Cl. B32B 9/04; G03G 15/08; G03G 15/02

(52) U.S. Cl. CPC G03G 15/0233; G03G 15/0808; G03G 21/18

(57) ABSTRACT

An electro-conductive member for electrophotography contributing to stable formation of high-quality electrophotographic images under a variety of environments is provided. The electro-conductive member has an electro-conductive substrate, an elastic layer on the substrate, and an electro-conductive surface layer covering a surface of the elastic layer, wherein the electro-conductive surface layer contains a matrix in which a urethane resin and a silicon oxide exist in a non-phase-separated state, and the matrix has a peak of a Si—N bond derived from a polysilazane in a wavelength region from 800 cm⁻¹ or higher and 950 cm⁻¹ or lower in an infrared absorption spectrum of the matrix.

### BACKGROUND OF THE INVENTION

Field of the Invention

The present invention relates to an electro-conductive member to be incorporated in an electrophotographic apparatus, and a process cartridge and an electrophotographic apparatus each using the member.

Description of the Related Art

Electro-conductive rollers such as a developing roller and a charging roller are installed on an image forming apparatus employing an electrophotographic system (hereinafter, referred to as “electrophotographic apparatus”), such as a copying machine, a printer or a facsimile machine. In the case where these electro-conductive rollers are repeatedly used, part of a developer or powder of paper may stick to the surface of the electro-conductive rollers and a film may be formed. Hereinafter, the phenomenon that part of a developer or powder of paper sticks and a film is formed is also referred to as “filming”.

It is described in Japanese Patent Application Laid-Open No. H09-90739 that an electro-conductive roller wherein a surface coating film containing a polysilazane is formed thereon can prevent unnecessary adhesion of a toner because of a low stickiness of the roller surface.

In recent years, it has been required to be capable of forming high-quality electrophotographic images stably even under a high-temperature and high-humidity environment such as an environment of a temperature of 30° C. and a relative humidity of 80% and under a low-temperature and low-humidity environment such as an environment of a temperature of 15° C. and a relative humidity of 10% as use environments of electrophotographic apparatuses have become diversified.

Thus, the present invention is directed to providing an electro-conductive member for electrophotography contributing to stable formation of high-quality electrophotographic images under a variety of environments. The present invention is also directed to providing a process cartridge and an electrophotographic apparatus each capable of stably forming high-quality electrophotographic images.

### SUMMARY OF THE INVENTION

According to one aspect of the present invention, there is provided an electro-conductive member for electrophotography, including an electro-conductive substrate, an elastic layer on the substrate, and an electro-conductive surface layer covering a surface of the elastic layer, wherein the electro-conductive surface layer contains a matrix in which a urethane resin and a silicon oxide exist in a non-phase-separated state, and the matrix has a peak of a Si—N bond derived from a polysilazane in a wavelength region from 800 cm⁻¹ or higher and 950 cm⁻¹ or lower in an infrared absorption spectrum of the matrix.

Moreover, according to another aspect of the present invention, there is provided a process cartridge configured to be detachably attachable to a body of an electrophotographic apparatus, the process cartridge including the electro-conductive member as at least one selected from the group consisting of a charging member and a developing member.

Furthermore, according to yet another aspect of the present invention, there is provided an electrophotographic apparatus including the electro-conductive member as at least one selected from the group consisting of a charging member and a developing member.

Further features of the present invention will become apparent from the following description of exemplary embodiments with reference to the attached drawings.

### BRIEF DESCRIPTION OF THE DRAWINGS

FIG. 1 is a cross sectional view illustrating an example of an electro-conductive roller according to the present invention.

FIG. 2 is a schematic configuration diagram illustrating an example of a process cartridge according to the present invention.

FIG. 3 is a schematic configuration diagram illustrating an example of an electrophotographic apparatus according to the present invention.

FIG. 4 is a conceptual diagram illustrating an example of a liquid-circulating dip coating apparatus.

FIG. 5 is a chart showing an infrared absorption spectrum of an example of an electro-conductive roller according to the present invention.

FIG. 6 is a conceptual diagram illustrating an example of a triboelectric charge quantity measurement apparatus.

### DESCRIPTION OF THE EMBODIMENTS

Preferred embodiments of the present invention will now be described in detail in accordance with the accompanying drawings.

According to studies conducted by the present inventors, fogging may occur in electrophotographic images in the case where the electro-conductive roller according to Japanese Patent Application Laid-Open No. H09-90739 is continuously used in a high-temperature and high-humidity environment or a low-temperature and low-humidity environment for example.

The present inventors have considered the reason as follows.

That is to say, the surface layer of the electro-conductive roller according to Japanese Patent Application Laid-Open No. H09-90739 contains a sintered body of a polysilazane, namely silica. A silica film exhibits electrical insulation properties, and therefore it is considered that electric charges are easy to accumulate excessively on the electro-conductive roller in the case where the electro-conductive roller is continuously used. It is to be noted that the excessive accumulation of electric charges is sometimes referred to as “charge-up” in the present specification. It is considered that, as a result of the excessive accumulation of electric charges, fogging occurs in electrophotographic images due to charge-up especially in the case where the electro-conductive roller according to Japanese Patent Application Laid-Open No. H09-90739 is continuously used as, for example, a developing roller under a severe environment such as a high-temperature and high-humidity environment or a low-temperature and low-humidity environment.

Based on such consideration, the present inventors have continued further studies. As a result, the present inventors have obtained an electro-conductive member for electrophotography that can stably give high-quality electrophotographic images even in the case where the electro-conductive member for electrophotography is used as a developing member or a charging member under a variety of environments.

The electro-conductive member for electrophotography according to an embodiment of the present invention includes: an electro-conductive substrate; an elastic layer on the substrate; and an electro-conductive surface layer covering a surface of the elastic layer. The electro-conductive surface layer contains a matrix in which a urethane resin and a silicon oxide exist in a non-phase-separated state. And the matrix has a peak of a Si—N bond derived from a polysilazane in a wavelength region from 800 cm⁻¹ or higher and 950 cm⁻¹ or lower in an infrared absorption spectrum of the matrix.

On the contrary, charge-up is hard to occur in the electro-conductive member according to an embodiment of the present invention because the surface layer has electro-conductivity. Moreover, the electro-conductive surface layer contains a urethane resin in addition to a silicon oxide and has a Si—N skeleton, and therefore the electro-conductive surface layer has a superior ability of imparting triboelectricity to toners. Thus, the electro-conductive surface layer can effectively suppress filming, and can also suppress the occurrence of fogging to electrophotographic images. As a result, high-quality electrophotographic images can stably be obtained.

It is important that the urethane resin and the silicon oxide exist in a non-phase-separated state in the electro-conductive surface layer. A surface layer in which the urethane resin and the silicon oxide are phase-separated makes the hardness of the surface of the electro-conductive roller uneven, and therefore it is hard to obtain a sufficient filming-suppressing effect.

Hereinafter, an electro-conductive member having a roller shape (hereinafter, also referred to as “electro-conductive roller”) will be described as an embodiment of the electro-conductive member according to the present invention, however the present invention is not limited thereto.

[Electro-Conductive Roller]

The electro-conductive roller includes: an electro-conductive mandrel being an electro-conductive substrate; at least one or more elastic layers formed on the mandrel; and an electro-conductive surface layer covering the surface of the elastic layer.

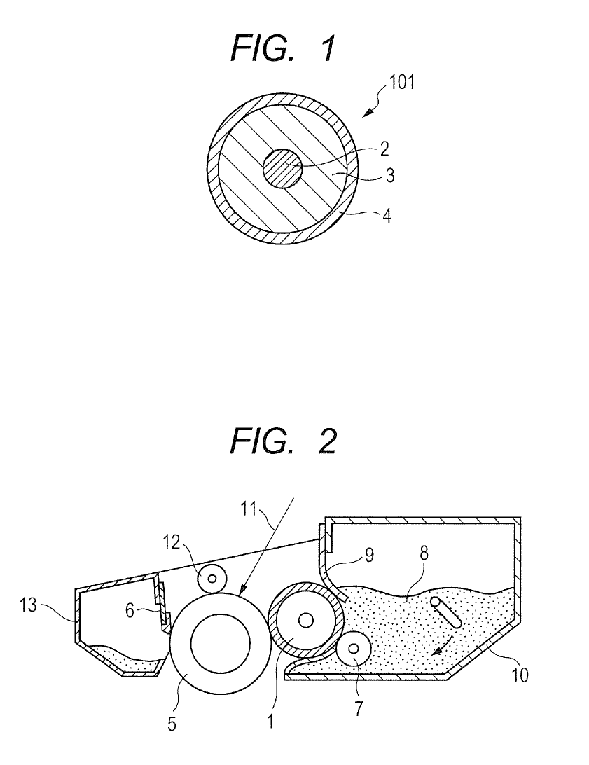

FIG. 1 illustrates a cross sectional view of an example of the electro-conductive roller. The electro-conductive roller 101 includes: a mandrel 2; an elastic layer 3 provided on the outer circumference of the mandrel 2; and an electro-conductive surface layer 4 provided on the outer circumference of the elastic layer 3.

[Mandrel]

The shape of the mandrel 2 is not particularly limited, and a hollow or solid mandrel can be used.

The mandrel 2 functions as an electrode and supporting member for the electro-conductive roller 101. The mandrel 2 can be made of an electro-conductive material such as: a metal or alloy such as aluminum, copper alloy or stainless steel; iron subjected to a plating treatment with chromium or nickel; or a synthetic resin having electro-conductivity. Moreover, the mandrel 2 may be a metal mandrel 2 subjected to a rust preventive treatment such as an oxidation treatment. Furthermore, the surface of the mandrel 2 may be subjected to a primer treatment as necessary.

The size of the mandrel 2 is not particularly limited, however the outer diameter may preferably be 4 mm or more and 20 mm or less and the length may preferably be 200 mm or more and 380 mm or less.

[Elastic Layer]

Various kinds of rubber materials that have conventionally been used for electro-conductive rollers can be used for the elastic layer 3. Specific examples thereof include the following rubber materials. Ethylene-propylene-diene copolymer rubber (EPDM), acrylonitrile-butadiene rubber (NBR), chloroprene rubber (CR), natural rubber (NR), isoprene rubber (IR), styrene-butadiene rubber (SBR), fluorocarbon rubber, silicone rubber, epichlorohydrin rubber, hydrides of NBR, and urethane rubber. These rubber materials can be used alone or in combination of two or more.

Moreover, an electro-conductivity imparting agent such as an ion conductive agent or an electron conductive agent can be contained in the elastic layer 3.

Examples of the ion conductive agent include the following materials. Salts of a group 1 metal in the periodic table (LiCF₃SO₃, NaClO₄, LiClO₄, LiAsF₆, LiBF₄, NaSCN, KSCN and NaCl), salts of a group 2 metal in the periodic table (such as Ca(ClO₄)₂ and Ba(ClO₄)₂), ammonium salts (NH₄Cl, (NH₄)₂SO₄ and NH₄NO₃), complexes of the salt and a monool (ethylene glycol monomethyl ether, ethylene glycol monoethyl ether, polyethylene glycol monomethyl ether and polyethylene glycol monoethyl ether), cationic surfactants, anionic surfactants and amphoteric surfactants.

Examples of the electron conductive agent include the following materials. Carbon-based substances (carbon black and graphite), metals and alloy (aluminum, silver, gold, tin-lead alloy and copper-nickel alloy) and metal oxides (zinc oxide, titanium oxide, aluminum oxide, tin oxide, antimony oxide, indium oxide and silver oxide).

Furthermore, substances obtained by subjecting the electron conductive agents to an electro-conductive metal plating such as copper, nickel or silver plating can also be used as an electro-conductivity imparting agent.

These electro-conductivity imparting agents can be in a powdery or fibrous form. Moreover, these electro-conductivity imparting agents can be used alone or in combination of two or more. Among the electro-conductivity imparting agents, carbon black is preferable because carbon black makes the control of the electro-conductivity easy and is economical.

Besides, various kinds of additives such as a plasticizer, a filler, an extender, a vulcanizing agent, a vulcanizing aid, a crosslinking aid, an anti-oxidizing agent, an anti-aging agent and a processing aid can be contained as necessary in the elastic layer 3 within a range that does not inhibit the function of the materials. Examples of the filler include silica, a quartz powder and calcium carbonate.

Examples of the method for forming the elastic layer 3 on the mandrel 2 include a molding method, an extrusion molding method, an injection molding method and a coating method. The surface of the elastic layer 3 can be modified by a surface-modifying method such as surface polishing, corona treatment, flame treatment or excimer treatment in order to improve adhesiveness with the electro-conductive surface layer 4.

The elastic layer 3 can have the elasticity that is required for the electro-conductive roller 101. Specifically, the hardness of the elastic layer 3 may preferably be 20 degrees or more and 80 degrees or less in terms of Asker C hardness. Moreover, the thickness of the elastic layer 3 may preferably be 2.0 mm or more and 6.0 mm or less.

[Electro-Conductive Surface Layer]

The electro-conductive surface layer 4 contains a matrix in which a urethane resin and a silicon oxide exist in a non-phase-separated state, and the matrix has a peak of a Si—N bond derived from a polysilazane in a range from 800 cm⁻¹ or higher and 950 cm⁻¹ or lower in the infrared absorption spectrum of the matrix.

In the case where a silica film consisting of a silicon oxide alone is made to be the outermost surface as described in Japanese Patent Application Laid-Open No. H09-90739, the silica film has insulation properties and therefore charge-up is liable to occur on the electro-conductive roller. Thus, fogging may occur in images due to charge-up under a severe environment such as a high-temperature and high-humidity environment or a low-temperature and low-humidity environment. On the contrary, the electro-conductive surface layer 4 has electro-conductivity, and therefore charge-up is hard to occur. Moreover, the electro-conductive surface layer 4 contains a urethane resin in addition to a silicon oxide and has a Si—N skeleton, and therefore the electro-conductive surface layer 4 has a superior ability of imparting triboelectricity to toners. Thus, the electro-conductive surface layer 4 can effectively suppress the filming and can also suppress the occurrence of fogging in electrophotographic images. As a result, high-quality electrophotographic images can stably be obtained.

Moreover, the electro-conductive surface layer 4 contains a silicon oxide, and therefore the surface hardness of the electro-conductive surface layer 4 is high when compared with the surface hardness of a layer consisting of a urethane resin alone. Thus filming of the electro-conductive roller 101 is suppressed. It is important here that the urethane resin and the silicon oxide exist in a non-phase-separated state. A surface layer in which the urethane resin and the silicon oxide are phase-separated makes the hardness of the surface of the electro-conductive roller 101 uneven, and therefore it is hard to obtain a sufficient filming-suppressing effect.

The urethane resin is a resin obtained by reacting a polyisocyanate compound having 2 or more isocyanate groups with a polyol compound having 2 or more hydroxy groups. It is to be noted that the reaction may be conducted adding a polyamine compound as necessary.

As the polyol, any one selected from the group consisting of aliphatic polyester polyols, polycarbonate polyols, polybutadiene polyols, polyisoprene polyols and acrylic polyols can suitably be used. Examples of the aliphatic polyester polyol include an aliphatic polyester polyol obtained through condensation reaction of polyethylene glycol, polytetramethylene glycol, 1,4-butanediol or 3-methyl-1,5-pentanediol with adipic acid or sebacic acid. Moreover, examples of the polycarbonate polyol include a polycarbonate diol obtained through condensation reaction of 1,6-hexanediol or 3-methyl-1,5-pentanediol with adipic acid and phosgene. Furthermore, examples of the acrylic polyol include binary copolymers of a hydroxy group-containing (meth)acrylate and a (meth)acrylic acid ester of an alkyl group having a number of carbon atoms of 8 or less, and ternary copolymers of a hydroxy group-containing (meth)acrylate, a (meth)acrylic acid ester of an alkyl group having a number of carbon atoms of 8 or less, and styrene.

Examples of the isocyanate compound reacted with these polyol components include, but not particularly limited to, aliphatic polyisocyanates such as ethylene diisocyanate and 1,6-hexamethylene diisocyanate (HDI), alicyclic polyisocyanates such as isophorone diisocyanate (IPDI), cyclohexane-1,3-diisocyanate and cyclohexane-1,4-diisocyanate, aromatic isocyanates such as 2,4-tolylene diisocyanate, 2,6-tolylene diisocyanate (TDI), diphenylmethane diisocyanate (MDI) and polymeric diphenylmethane diisocyanate, and modified products thereof (urethane-modified products, allophanate-modified products, biuret-modified products and isocyanurate-modified products). Moreover, mixtures thereof can also be used.

The silicon oxide generally means a compound represented by SiOx (0<x≦2). Whether the silicon oxide exists or not in the electro-conductive surface layer 4 can be confirmed by infrared absorption spectrum analysis.

Examples of the method for making the surface layer containing the urethane resin and the silicon oxide exist in a non-phase-separated state include, but not particularly limited to, a method comprising a step of baking a film of a coating material containing a polysilazane and raw materials for urethane resin, i.e. an isocyanate compound and a polyol compound; and applying the coating material.

The polysilazane reacts with water to convert to an Si—O skeleton for the most part as is given as an example in the following formula (2).

SiH₂NH+2H₂O→SiO₂+NH₃+2H₂ (2)

However, in the coating material for forming a surface layer, it is considered that the side reaction between the polysilazane and an isocyanate group as shown in the following formula (3) partially occurs. Therefore, the Si—N skeleton can be exist in the matrix of the electro-conductive surface layer 4, and as a result of that, the urethane resin and the silicon oxide can co-exist in the matrix in a non-phase-separated state.

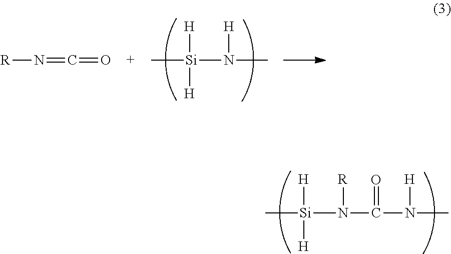

The polysilazane may preferably be a polysilazane having a structural unit represented by the following formula (1).

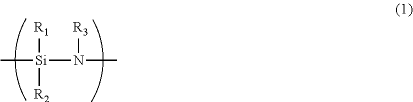

In the formula (1), R₁ to R₃ each independently represent any one selected from the group consisting of a hydrogen atom, an alkyl group, an alkylamino group and an alkoxy group, with proviso that a case in which all of R₁ to R₃ are hydrogen atoms is excluded.

The polysilazane having a structural unit represented by the formula (1) has a good compatibility with urethane resins, making the phase separation hard to occur, and therefore is preferably used. It is to be noted that the number of carbon atoms of the alkyl group, the alkylamino group and the alkoxy group is preferably 1 or more and 6 or less, particularly preferably 1 or more and 3 or less.

In the formula (1), at least one of R₁ to R₃ may preferably be an alkylamino group. The alkylamino group contains a nitrogen atom to have a high electron-donating ability, and therefore has a superior ability of imparting triboelectricity to developers to exhibit a better effect on preventing fogging.

The polysilazane can be produced by the methods reported in Japanese Patent Application Laid-Open No. 560-145903, Japanese Patent Application Laid-Open No. S61-89230 and Polym. Prepr. Am. Chem. Soc., Div. Polym. Chem., 25, 10(1984).

In the case where the polysilazane is prepared as a solution by dissolving the polysilazane in a solvent, the following compounds can be used as the solvent. Saturated hydrocarbon compounds (pentane, hexane, heptane, octane, nonane and cyclohexane), aromatic compounds (benzene, toluene and xylene), ethers (dimethyl ether and diethyl ether) and ketones (methyl ethyl ketone and methyl isobutyl ketone).

The electro-conductive surface layer 4 can be formed by applying a coating material for forming a surface layer, the coating material containing: a polysilazane; and an isocyanate compound and a polyol compound each being a raw material for a urethane resin on the elastic layer 3, and drying and then heating the coating material.

A catalyst can be used in order to facilitate the conversion reaction of the polysilazane to a silicon oxide. Preferable examples of the catalyst include heterocyclic compounds, amines, organic acids, inorganic acids and metal salts of a carboxylic acid.

The amount of the catalyst added is preferably 0.01% by mass or more and 10% by mass or less, particularly preferably 0.1% by mass or more and 1.0% by mass or less relative to the polysilazane.

In order to facilitate the reaction represented by the formula (3), the isocyanate compound can be blended so that the isocyanate index may fall within the range from 1.5 or more and 5.0 or less. The isocyanate index shows a ratio of the number of moles of the isocyanate groups in an isocyanate compound to the number of moles of the hydroxy groups in a polyol compound ([NCO]/[OH]). When the isocyanate index falls within the range, Si—N bonds can be made to exist in the matrix of the surface layer more easily, and therefore, the matrix in which the urethane resin and the silicon oxide co-exist in a non-phase-separated state, can be obtained more easily. Thus, in the present disclosure, the surface layer containing a cured product of a coating material containing a polysilazane, a isocyanate compound and a polyol compound, and having the isocyanate index of 1.5 or more and 5.0 or less, is preferable.

The polysilazane is contained in the coating material for forming a surface layer preferably by 5 parts by mass or more and 60 parts by mass or less, particularly preferably by 5 parts by mass or more and 30 parts by mass or less relative to 100 parts by mass of the raw material for the urethane resin (the total amount of the isocyanate compound and the polyol compound) from the standpoint of making the silicon oxide exist in a non-phase-separated state.

The non-phase-separated state means a state in which a boundary between the urethane resin and the silicon oxide does not exist in the matrix when the surface of the electro-conductive surface layer 4 is observed by a scanning electron microscope (SEM).

In the infrared absorption spectrum of the electro-conductive surface layer 4 thus prepared, a peak of a Si—N bond derived from the polysilazane exists in a range from 800 cm⁻¹ or higher and 950 cm⁻¹ or lower. The detailed measurement method of the infrared absorption spectrum analysis will be shown in Examples.

In the method for forming the electro-conductive surface layer 4 using a polysilazane, which is different from a CVD method, the electro-conductivity can be exhibited in the surface layer by using an electro-conductivity imparting agent together in a urethane coating material. As the electro-conductivity imparting agent, the same electro-conductivity imparting agent given as examples of the electro-conductivity imparting agent for the elastic layer can be used. Among the electro-conductivity imparting agents, carbon black can preferably be used.

The surface potential of the electro-conductive surface layer 4 is preferably 2 V or higher and 40 V or lower, particularly preferably 2 V or higher and 10 V or lower in the case where the electro-conductive roller 101 is used as a developing roller. In the case where the electro-conductive roller 101 is used as a charging roller, the surface potential of the electro-conductive surface layer 4 is preferably 5 V or higher and 60 V or lower, particularly preferably 5 V or higher and 30 V or lower.

The surface potential of the electro-conductive surface layer 4 can be measured as follows. A dielectric relaxation analysis apparatus (trade name: DRA-2000L, manufactured by Quality Engineering Associates, Inc.) is used for the measurement of the surface potential. This apparatus includes a scanner, a non-contact electrostatic potentiometer and so on, and the surface potential at an arbitrary position on the roller surface can be measured by scanning a carriage including a corona charging device and an electrostatic probe built therein in an axial direction. The surface potential to be measured here denotes a residual potential on the roller surface, the potential measured with a probe that is positioned in a backward direction to the travelling direction of the charging device after charging with the charging device. The measurement is conducted at 240 points in the longitudinal direction of the surface layer at an interval of 1 mm and at 36 points in the circumferential direction at an interval of 10°, measuring 8640 points in total. The distance between the surface layer and the probe is set to 0.76 mm, the scanning rate of the carriage is set to 400 ram/sec, and the applied voltage to the corona charging device is set to 6 kV.

In the case where surface roughness is required for the electro-conductive roller 101, a fine particle for controlling roughness may be added to the coating material (dispersion liquid) for forming a surface layer. As the fine particle for controlling roughness, fine particles of polyurethane resins, polyester resins, polyether resins, polyamide resins, acrylic resins and polycarbonate resins can be used. The particle for controlling roughness can have a volume average particle diameter of 3 μm or more and 20 μm or less. Moreover, the amount of the particle added to the electro-conductive surface layer 4 can be 1 part by mass or more and 50 parts by mass or less relative to 100 parts by mass of the solid content of the resin in the electro-conductive surface layer 4.

The surface of the electro-conductive roller 101 preferably has a nanoindenter hardness of 0.8 GPa or higher and 10.0 GPa or lower, particularly preferably 1.5 GPa or higher and 8.0 GPa or lower. The nanoindenter hardness can be measured by a nanoindentation method. When the nanoindenter hardness falls within the range, the filming-suppressing effect becomes particularly favorable.

Furthermore, a crosslinking agent, a plasticizer, a filler, an extender, a vulcanizing agent, a vulcanizing aid, a crosslinking aid, an anti-oxidizing agent, an anti-aging agent, a processing aid or a levelling agent can be contained in the electro-conductive surface layer 4 within a range that does not inhibit the function.

The thickness of the electro-conductive surface layer 4 can be 1 μm or more and 100 μm or less. When the thickness of the electro-conductive surface layer 4 is 1 μm or more, the friction resistance of the electro-conductive roller 101 is favorable. Moreover, when the thickness of the electro-conductive surface layer 4 is 100 μm or less, the hardness of the surface of the electro-conductive roller 101 does not become too high, making it hard to deteriorate a developer. Thus, sticking of the developer to the surface of the electro-conductive roller 101 can further be suppressed. The thickness of the electro-conductive surface layer 4 can be 1 μm or more and 20 μm or less considering the damage to the developer.

The method for forming the electro-conductive surface layer 4 is not particularly limited, and various known methods can be used. For example, the electro-conductive surface layer 4 can be formed by mixing each component for the electro-conductive surface layer 4 in a solvent to make a coating material, then applying the coating material onto the mandrel 2 or the elastic layer 3 to form a coating film, and thereafter drying and solidifying, or curing the coating film.

Known dispersing apparatuses making use of beads, such as a sand mill, a paint shaker, a Dyno mill and a pearl mill can suitably be utilized for mixing each component.

As a coating method, dip coating, ring coating, spray coating or roll coating can be adopted. Particularly with respect to the dip coating, a method in which a coating material for forming an electro-conductive surface layer 4 is overflown from an upper end of a dipping vat is simple and excellent in production stability as described in Japanese Patent Application Laid-Open No. S57-5047 and therefore can suitably be utilized.

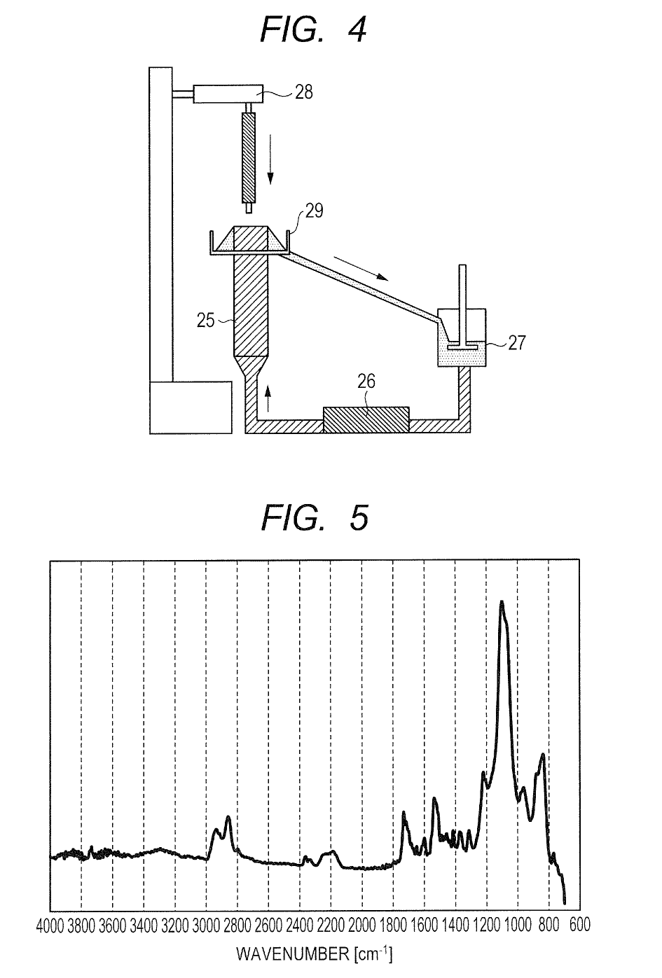

FIG. 4 is a schematic diagram illustrating a dip coating apparatus. A cylindrical dipping vat 25 has an inner diameter slightly larger than the outer diameter of the electro-conductive roller 101 and has depth larger than the length of the electro-conductive roller in the axial direction. A ring-shaped liquid receiving section 29 is provided at the outer circumferential portion of the upper end of the dipping vat 25, and the liquid receiving section is connected to a stirring tank 27 through a pipe. Moreover, the bottom portion of the dipping vat 25 is also connected to the bottom portion of the stirring tank 27. The coating material in the stirring tank 27 is fed into the bottom portion of the dipping vat 25 with a liquid feed pump 26. The coating material fed into the dipping vat is overflown from the upper end portion of the dipping vat 25 and returns to the stirring tank 27 through the liquid receiving section 29.

The mandrel 2 provided with the elastic layer 3 is anchored almost vertically to a lifting apparatus 28 and can move in an almost vertical direction. The coating material can be applied onto the elastic layer 3 by dipping the mandrel 2 provided with the elastic layer 3 into the dipping vat 25 and then lifting the mandrel 2.

<Process Cartridge>

The process cartridge according to an embodiment of the present invention is a process cartridge that can suitably be used for a body of an electrophotographic apparatus, and is configured to be detachably attachable to the body of the electrophotographic apparatus. The process cartridge includes the electro-conductive roller 101 as at least one roller selected from the group consisting of a charging roller and a developing roller.

FIG. 2 is a schematic diagram illustrating a process cartridge that can be installed on a non-magnetic one-component developing system electrophotographic apparatus as an example of the process cartridge.

In FIG. 2, a developing device 10 includes: a developing roller 1 that is arranged at an opening portion of a developing container storing a developer 8 and carries and conveys the developer; a developer-supplying roller 7 that supplies the stored developer 8 to the developing roller 1; and a developer amount-regulating member 9 that regulates the amount of developer carried (thickness of toner layer) on the developing roller 1. The developing roller 1 develops electrostatic latent images on an electrophotographic photosensitive member 5 to form toner images.

The electrophotographic photosensitive member 5 is a rotary drum type image bearing member and is rotary-driven at a predetermined circumferential speed (process speed) by a rotary mechanism that is not illustrated in the figure.

The charging roller 12 is made to contact with the electrophotographic photosensitive member 5 at a predetermined pressing force and is rotary-driven in a forward direction to the rotation of the electrophotographic photosensitive member 5. The surface of the electrophotographic photosensitive member 5 is uniformly subjected to a charging treatment so as to have a predetermined positive or negative potential by applying a predetermined DC voltage to the charging roller 12.

Irradiation of the face of the electrophotographic photosensitive member 5 subjected to a charging treatment with light 11 corresponding to the intended image formation by means of an image exposing apparatus not shown in the figure selectively lowers (attenuates) the potential of the exposed portion of the face subjected to the charging treatment to form electrostatic latent images on the electrophotographic photosensitive member 5. Known methods such as a laser beam scanner can be used for the image exposing apparatus.

Moreover, the process cartridge may include: a cleaning member 6 that removes the developer left on the electrophotographic photosensitive member 5; and a container 13 that stores the recovered developer.

<Electrophotographic Apparatus>

The electrophotographic apparatus according to an embodiment of the present invention includes the electro-conductive roller 101 as at least one roller selected from the group consisting of a charging roller and a developing roller. The electrophotographic apparatus is not limited to copying machines, facsimile machines and printers as long as the electrophotographic apparatus includes the electro-conductive roller 101 according to the present invention.

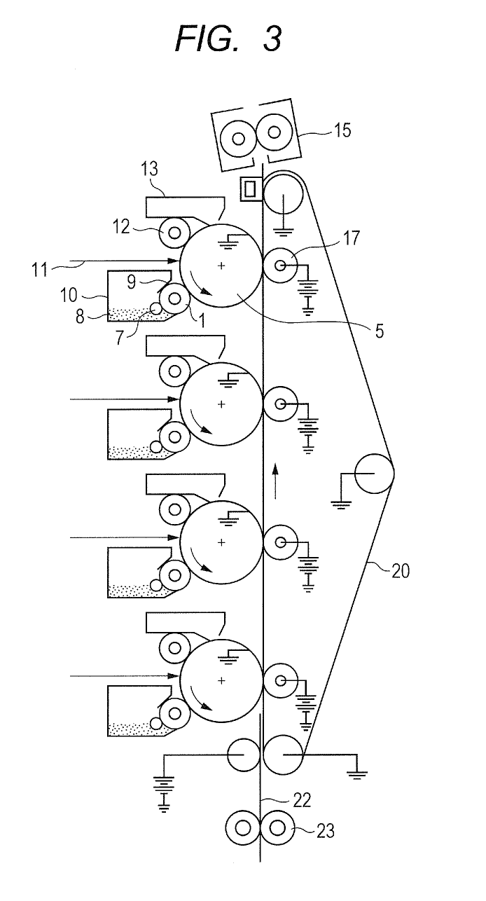

FIG. 3 is a schematic diagram illustrating a non-magnetic one-component developing system electrophotographic apparatus as an example of the electrophotographic apparatus. In the electrophotographic apparatus, electrophotographic stations for developing electrostatic latent images using each of 4 color developers are arranged in sequence in the direction of rotation of the transfer-transport belt 20. These electrophotographic stations include: the electrophotographic photosensitive member 5; the charging roller 12; and the developing device 10. A toner image developed onto the electrophotographic photosensitive member 5 in the electrophotographic station is transferred to transfer paper 22 with a transfer roller 17. It is to be noted that the transfer paper 22 is conveyed on the transfer-transport belt 20 with a paper feed roller 23. And, a fixing device 15 fixes the unfixed toner images formed on the transfer paper 22 on the paper and discharges the transfer paper 22 to the outside of the apparatus.

According to an aspect of the present invention, an electro-conductive roller that makes developers and contaminations such as a powder of paper hard to stick to the surface thereof and that makes filming hard to occur can be obtained. Moreover, an electro-conductive roller that can stably give high-quality electrophotographic images even under a variety of environments can be obtained.

Furthermore, according to another aspect of the present invention, a process cartridge and an electrophotographic apparatus each enabling stable formation of high-quality electrophotographic images can be obtained.

### EXAMPLES

Hereinafter, specific examples and comparative examples in which the electro-conductive surface layer 4 according to the present invention was applied to the surface layer of the electro-conductive roller as illustrated in FIG. 1 will be described, however the present invention is not limited to these examples.

[1. Preparation of Elastic Rollers]

(Elastic Roller No. 1)

A primer (trade name: DY35-051; manufactured by Dow Corning Toray Co., Ltd.) was applied on a mandrel made of stainless steel (SUS 304), the mandrel having a diameter of 6 mm and then burned for 20 minutes in an oven heated at a temperature of 180° C.

The obtained mandrel having a primer layer formed on the circumferential face thereof was arranged in a die, and an addition type silicone rubber composition obtained by mixing the materials described in Table 1 below was injected to a cavity in the die.

TABLE 1

| Material | Amount blended |
|---|---|
| Liquid silicone rubber | 100 parts by mass |
| (trade name: SE 6905 A/B, manufactured by | |
| Dow Corning Toray Co., Ltd.) | |
| Carbon black | 10 parts by mass |
| (trade name: TOKABLACK #4300, manufactured | |
| by Tokai Carbon Co., Ltd.) | |
| Silica powder as heat resistance imparting agent | 0.2 parts by mass |
| (trade name: Aerosil 130, manufactured by Nippon | |
| Aerosil Co., Ltd.) | |
| Platinum catalyst | 0.1 parts by mass |
| (trade name: SIP 6832.2, manufactured by | |
| Gelest Inc.) | |

Subsequently, the die was heated at 150° C. for 15 minutes to vulcanize and cure the silicone rubber. The mandrel having a cured silicone rubber layer formed on the circumferential face thereof was removed from the die and then further heated at a temperature of 180° C. for 1 hour to complete curing reaction of the silicone rubber layer. In this way, an elastic roller No. 1 having a silicone rubber elastic layer 3 whose diameter was 12 mm formed on the circumferential face of the mandrel 2 was prepared.

(Elastic Roller No. 2)

A round rod obtained by subjecting a surface of free-cutting steel to an electroless nickel plating treatment, the rod having a total length of 252 mm and an outer diameter of 6 mm was provided. Subsequently, an adhesive was applied over the whole circumference of the round rod in a range of a width of 230 mm excluding each end portion of a length of 11 mm from each end to make a mandrel. As the adhesive, a hot melt type electro-conductive adhesive was used. Moreover, a roll coater was used for application.

Subsequently, each material described in Table 2 below was mixed with a pressure kneader to obtain an A-kneaded rubber composition.

TABLE 2

| Material | Amount blended |
|---|---|
| Acrylonitrile-butadiene rubber | 100 parts by mass |
| (trade name: Nipol DN219, manufactured by Zeon | |
| Corporation; central value of amount of bound | |
| acrylonitrile = 33.5 and specific gravity = 0.98) | |
| Carbon black | 40 parts by mass |
| (trade name: TOKABLACK #4300, manufactured | |
| by Tokai Carbon Co., Ltd.) | |
| Calcium carbonate | 20 parts by mass |
| (trade name: Nanox #30, manufactured by Maruo | |
| Calcium Co., Ltd.) | |
| Stearic acid | 1.0 parts by mass |
| (trade name: Stearic acid S, manufactured by Kao | |
| Corporation) | |

Further, 166.0 parts by mass of the A-kneaded rubber composition and each material shown in Table 3 below were mixed with an open roll to prepare an unvulcanized rubber composition.

TABLE 3

| Material | Amount blended |
|---|---|
| Sulfur | 1.2 parts by mass |
| (trade name: Sulfax 200S, manufactured by Tsurumi | |
| Chemical Co., Ltd.) | |
| Tetrabenzylthiuram disufide | 4.5 parts by mass |
| (trade name: Sanceler TBZTD, manufactured by | |
| Sanshin Chemical Industry Co., Ltd.) | |

Subsequently, a dice having an inner diameter of 16.5 mm was attached to a crosshead extruder including a mechanism that supplies the mandrel 2 and a mechanism that discharges an unvulcanized rubber roller. And the temperature of the extruder and dice (crosshead) was adjusted to 80° C., and the conveyance speed of the electro-conductive mandrel was adjusted to 60 mm/sec. Under the conditions, the unvulcanized rubber composition was supplied with the extruder, and the electro-conductive mandrel was coated in the crosshead with the unvulcanized rubber composition as the elastic layer. Subsequently, the mandrel having the elastic layer formed thereon was put into a hot-air vulcanizing furnace heated at 170° C. and was heated for 60 minutes. After the mandrel was cooled, the end portions of the elastic layer were ablated, and the surface of the elastic layer was polished with a rotary grindstone to prepare an elastic roller No. 2 having a diameter of 8.4 mm at each position located 90 mm away from the central portion in the axis direction toward each end side of the mandrel and having a diameter at the central portion of 8.5 mm.

[2. Preparation of Polysilazane Solutions and Polyurethane Coating Materials]

<Preparation of Polysilazane Solutions>

(Polysilazane Solution A-1)

A gas blowing tube, a dry ice condenser, a stirrer and a thermometer were fitted to a four-necked flask. After the air in the system was sufficiently replaced by nitrogen to dry the inside of the system, 350 ml of dry pyridine was put into the four-necked flask, and the liquid temperature was kept at 15° C.

Subsequently, 63.4 g of dichlorosilane was added, and an ammonia gas dried through a sodium hydroxide column and an activated carbon tube was blown into the solution at a rate of 2.0 ml/min. under stirring. When heat generation was subsided, blowing the ammonia gas was stopped. After the inside of the four-necked flask was washed with dry pyridine, the reaction solution was filtered under a dry nitrogen atmosphere. After the solvent was removed from the filtrate under reduced pressure, 100.0 g of xylene and 0.5 g of triethylamine were gradually added under stirring with a stirring motor, and the resulting solution was further mixed and stirred with the stirring motor for 20 minutes to prepare a polysilazane solution A-1. The solid content of the obtained solution was 20.5% by mass. Moreover, the solution was measured by infrared spectroscopy to confirm a characteristic absorption spectrum derived from a Si—H group at around 2200 cm⁻¹.

(Polysilazane Solutions A-2 to 14)

Polysilazane solutions A-2 to 14 were obtained in the same manner as in the synthesis of the polysilazane solution A-1 except that the silane raw material and the amount thereof added and the ammonia raw material and the amount thereof added were changed as described in Table 4.

TABLE 4

| | | | | | Solid |
|---|---|---|---|---|---|
| | | Amount | | Amount | content |
| Polysilazane | | added | Ammonia raw | added | [% by |
| solution | Silane raw material | [g] | material | [g] | mass] |
| A-1 | Dichlorosilane | 63.4 | Ammonia | 58.9 | 20.5 |
| A-2 | Methyldichlorosilane | 68.5 | Ammonia | 61.2 | 24.5 |
| A-3 | Phenylmethyldichlorosilane | 72.3 | Ammonia | 59.3 | 30.3 |
| A-4 | Ethoxydichlorosilane | 64.6 | Ammonia | 59.4 | 21.2 |
| A-5 | Dimethyldichlorosilane | 72.5 | Ammonia | 62.1 | 28.5 |
| A-6 | Dichlorosilane | 63.6 | Methylamine | 64.1 | 19.8 |
| A-7 | Methyldichlorosilane | 67.4 | Methylamine | 58.9 | 18.5 |
| A-8 | Dimethyldichlorosilane | 71.2 | Methylamine | 59.9 | 26.9 |
| A-9 | Dichlorosilane | 67.5 | 1,3-Diaminopropane | 61.2 | 22.5 |
| A-10 | Methyldichlorosilane | 73.5 | 1,3-Diaminopropane | 57.5 | 26.4 |
| A-11 | Dimethyldichlorosilane | 72.1 | 1,3-Diaminopropane | 62.2 | 28.2 |
| A-12 | Aminopropyldichlorosilane | 72.4 | Ammonia | 58.9 | 26.1 |
| A-13 | Aminopropyldichlorosilane | 72.5 | Methylamine | 59.1 | 25.5 |
| A-14 | Aminopropyldichlorosilane | 70.5 | 1,3-Diaminopropane | 58.8 | 24.3 |

<Preparation of Urethane Coating Materials>

(Urethane Coating Material B-1)

Materials described in Table 5 below were stirred and mixed, and dissolved and mixed in methyl ethyl ketone (MEK) so that the total solid content was 30% by mass. And, zirconia beads (central particle diameter of 0.8 mm) were charged in the mixed solution so that the mass of the zirconia beads were twice the mass of the mixed solution, and the resulting mixture was mixed with a sand mill the inner wall of which was made of zirconia. To the mixed solution, 40 parts by mass of a polyurethane resin particle (trade name: Art Pearl C 400 (volume average particle diameter of 14 μm); manufactured by Negami Chemical Industrial Co., Ltd.) based on 100 parts by mass of polytetramethylene ether glycol was added, and stirred and dispersed with a ball mill to obtain a urethane coating material B-1. The isocyanate index was adjusted so as to be 1.6.

TABLE 5

| Material | Amount blended |
|---|---|
| Polytetramethylene ether glycol | 100 parts by mass |
| (trade name: PTMG 3000, manufactured by | |
| Mitsubishi Chemical Corporation) | |
| Modified polyisocyanate | 85.0 parts by mass |
| (trade name: Coronate 2507, manufactured by | |
| Tosoh Corporation) | |
| *NCO content = 11.2 to 12.2% and solid | |
| content = 79 to 82% | |
| Carbon black | 35.5 parts by mass |
| (trade name: MA 230, manufactured by Mitsubishi | |
| Chemical Corporation) | |

(Urethane Coating materials B-2 to 7)

Polyurethane coating materials B-2 to 7 were obtained in the same manner as in the preparation of the urethane coating material B-1 except that the materials and the amounts added were changed to the materials and the amounts added described in Tables 6 to 11 below. It is to be noted that the isocyanate index was adjusted so as to be 1.6 in any of the urethane coating materials.

TABLE 6
Urethane coating material B-2

| Material | Amount blended |
|---|---|
| Polyester polyol | 100 parts by mass |
| (trade name: Kuraray Polyol P-3050, | |
| manufactured by Kuraray Co., Ltd.) | |
| Polyisocyanate | 25.8 parts by mass |
| (trade name: Coronate L, manufactured by | |
| Tosoh Corporation) | |
| * NCO content = 12.7 to 13.7% and solid | |
| content = 74 to 76% | |
| Carbon black | 32.3 parts by mass |
| (trade name: MA 230, manufactured by Mitsubishi | |
| Chemical Corporation) | |

TABLE 7
Urethane coating material B-3

| Material | Amount blended |
|---|---|
| Acrylic polyol | 100 parts by mass |
| (trade name: Acrydic A-848RN, manufactured | |
| by DIC Corporation) | |
| Polyisocyanate | 14.5 parts by mass |
| (trade name: Coronate L, manufactured by | |
| Tosoh Corporation) | |
| Carbon black | 21.2 parts by mass |
| (trade name: MA 230, manufactured by Mitsubishi | |
| Chemical Corporation) | |

TABLE 8
Urethane coating material B-4

| Material | Amount blended |
|---|---|
| Polycarbonate polyol | 100 parts by mass |
| (trade name: Kuraray Polyol C-3090, manufactured | |
| by Kuraray Co., Ltd.) | |
| Polyisocyanate | 44.7 parts by mass |
| (trade name: Coronate L, manufactured by Tosoh | |
| Corporation) | |
| Carbon black | 35.3 parts by mass |
| (trade name: MA 230, manufactured by Mitsubishi | |
| Chemical Corporation) | |

TABLE 9
Urethane coating material B-5

| Material | Amount blended |
|---|---|
| Polybutadiene polyol | 100 parts by mass |
| (trade name: NISSO-PB G-3000, manufactured by | |
| Nippon Soda Co., Ltd.) | |
| * polybutadiene having hydroxy groups at both | |
| ends, number average molecular weight = 3000, | |
| fine structure: 90% or more of 1,2-vinyl and 10% or | |
| less of trans-1,4. | |
| Polyisocyanate | 25.6 parts by mass |
| (trade name: Coronate L, manufactured by Tosoh | |
| Corporation) | |
| Carbon black | 28.3 parts by mass |
| (trade name: MA 230, manufactured by Mitsubishi | |
| Chemical Corporation) | |

TABLE 10
Urethane coating material B-6

| Material | Amount blended |
|---|---|
| Polyisoprene polyol | 100 parts by mass |
| (trade name: Poly-ip, manufactured by Idemitsu | |
| Kosan Co., Ltd.) | |
| Polyisocyanate | 36.6 parts by mass |
| (trade name: Coronate L, manufactured by Tosoh | |
| Corporation) | |
| Carbon black | 29.4 parts by mass |
| (trade name: MA 230, manufactured by Mitsubishi | |
| Chemical Corporation) | |

TABLE 11
Urethane coating material B-7

| Material | Amount blended |
|---|---|
| Polytetramethylene ether glycol | 100 parts by mass |
| (trade name: PTMG 3000, manufactured by | |
| Mitsubishi Chemical Corporation) | |
| Modified polyisocyanate | 85.0 parts by mass |
| (trade name: Coronate 2507, manufactured by | |
| Tosoh Corporation) | |
| Quaternary ammonium salt | 3.5 parts by mass |
| (trade name: ADK CIZER LV-70, manufactured by | |
| ADEKA Corporation) | |

(Urethane Coating Material B-8)

A urethane coating material B-8 was obtained in the same manner as in the preparation of the urethane coating material B-1 except that the amounts of the materials added for use in the urethane coating material B-1 were changed to the values as described in Table 12 below so that the isocyanate index was 0.9.

TABLE 12
Urethane coating material B-8

| Material | Amount blended |
|---|---|
| Polytetramethylene ether glycol | 100 parts by mass |
| (trade name: PTMG 3000, manufactured by | |
| Mitsubishi Chemical Corporation) | |
| Modified polyisocyanate | 47.8 parts by mass |
| (trade name: Coronate 2507, manufactured by | |
| Tosoh Corporation) | |
| Carbon black | 35.5 parts by mass |
| (trade name: MA 230, manufactured by Mitsubishi | |
| Chemical Corporation) | |

[3. Preparation of Electro-Conductive Rollers]

### Example 1

The previously prepared polysilazane solution A-14 and urethane coating material B-1 were weighed by the amounts as described in Table 13 below and gradually added and mixed with each other under stirring with a stirring motor. The resulting mixture was further mixed and stirred with the stirring motor for 20 minutes to obtain a coating material C-1 for forming a surface layer.

The elastic roller No. 1 was immersed in the coating material C-1 to form a coating film of the coating material on the surface of the elastic layer, and the coating film was dried. Heating treatment was further conducted at a temperature of 160° C. for 1 hour. In this way, an electro-conductive roller according to Example 1 in which a surface layer having a film thickness of 15 μm was provided on the outer circumference of the elastic layer was prepared.

### Examples 2 to 30

Electro-conductive rollers according to Examples 2 to 30 were prepared in the same manner as in Example 1 except that the polysilazane solution and the urethane coating material were changed to kinds and amounts as described Table 13 below.

### Example 31

An electro-conductive roller according to Example 31 was prepared in the same manner as in Example 1 except that the elastic roller No. 1 was changed to the elastic roller No. 2.

### Example 32

An electro-conductive roller according to Example 32 was prepared in the same manner as in Example 20 except that the elastic roller No. 1 was changed to the elastic roller No. 2.

### Comparative Example 1

The elastic roller No. 1 was immersed in the urethane coating material B-1 to form a coating film of the coating material on the surface of the elastic layer, and the coating film was dried. A urethane coating film having a film thickness of 15 μm was provided on the outer circumference of the elastic layer by further conducting a heating treatment at a temperature of 160° C. for 1 hour. Thereafter, the elastic roller having a urethane coating film formed thereon was further immersed in the polysilazane solution A-1, dried, and subjected to a heating treatment at a temperature of 160° C. for 1 hour. In this way, an electro-conductive roller according to Comparative Example 1 was prepared.

### Comparative Example 2

An electro-conductive roller according to Comparative Example 2 was prepared in the same manner as in Comparative Example 1 except that the polysilazane solution A-1 was changed to the polysilazane solution A-14.

### Comparative Example 3

The elastic roller No. 1 was set up in a plasma CVD apparatus. Then, the pressure in the vacuum chamber was reduced to 1.0 Pa with a vacuum pump. Thereafter, a mixed gas of 1.5 sccm (Standard Cubic Centimeter per Minutes) of hexamethyldisilazane vapor, 1.3 sccm of oxygen and 22.0 sccm of an argon gas was introduced in the vacuum chamber as raw material gases, and the pressure in the vacuum chamber was set to 27.5 Pa. After the pressure became constant, 120 W of electric power having a frequency of 13.56 MHz was supplied to plate electrodes from a high-frequency power source to generate plasma between the electrodes. The elastic roller No. 1 set up in the vacuum chamber was revolved at 30 rpm to conduct treatment for 3 minutes. After the completion of the treatment, the power supply was stopped, the raw material gases left in the vacuum chamber was discharged, and the air was introduced in the vacuum chamber till the pressure reached atmospheric pressure. In this way, an electro-conductive roller according to Comparative Example 3 was prepared.

### Comparative Example 4

Under stirring with a stirring motor, 100 parts by mass of silica sol (trade name: Grasca HPC 7002; manufactured by JSR Corporation) and 30 parts by mass of an alkyl alkoxy silane (trade name: Grasca HPC 402 H; manufactured by JSR Corporation) were gradually added and mixed. Stirring was further conducted for 5 minutes with the stirring motor. The elastic roller No. 1 was immersed in the coating material to form a coating film of the coating material on the surface of the elastic layer, and the coating film was dried. The elastic roller having the coating film formed thereon was further subjected to a heating treatment at a temperature of 120° C. for 1 hour. In this way, an electro-conductive roller according to Comparative Example 4 in which a surface layer having a film thickness of 5 μm was provided on the outer circumference of the elastic layer was prepared.

### Comparative Example 5

To 100 parts by mass of the urethane coating material B-1, 20 parts by mass of a spherical silica particle (trade name: Excelica; manufactured by Tokuyama Corporation) was added, and the resulting mixture was stirred and dispersed with a ball mill. The elastic roller No. 1 was immersed in the coating material to form a coating film of the coating material on the surface of the elastic layer, and the coating film was dried. The elastic roller having the coating film formed thereon was further subjected to a heating treatment at a temperature of 120° C. for 1 hour. In this way an electro-conductive roller according to Comparative Example 5 in which a surface layer having a film thickness of 5 μm was provided on the outer circumference of the elastic layer was prepared.

### Comparative Example 6

An electro-conductive roller according to Comparative Example 6 was prepared in the same manner as in Comparative Example 3 except that the elastic roller No. 1 was changed to the elastic roller No. 2.

[4. Evaluation of Electro-Conductive Rollers]

First of all, evaluation of the following items was conducted for the previously prepared electro-conductive rollers according to Examples 1 to 32 and Comparative Examples 1 to 6.

<Confirmation of Si—N Bond>

Whether a Si—N bond existed or not was confirmed in the matrix on the surface of each electro-conductive roller. Whether the Si—N bond existed or not was measured using a germanium prism with an analyzing apparatus (trade name: FTIR-8300; manufactured by Shimadzu Corporation) to which an IR microscope (trade name: AIM-8000R; manufactured by Shimadzu Corporation) was connected. The measurement conditions are as follows.

Measurement mode: absorbance mode;
Range of measured wavenumbers: 700 to 4000 cm⁻¹;
Resolution: 4 cm⁻¹;
Detector: MCT (HgCdTe) detector; and
Cumulative number: 128 times.

Specifically, the IR spectrum was measured by pressing the surface of the electro-conductive roller against the germanium prism. In the obtained IR spectrum chart, whether a spectrum peak assigned to the Si—N bond existed or not in a wavelength region from 800 cm⁻¹ or higher and 950 cm⁻¹ or lower was confirmed. Whether the spectrum peak existed or not for each electro-conductive roller is shown in Table 13. Moreover, a spectrum chart for the surface of the electro-conductive roller according to Example 1 is illustrated in FIG. 5.

<Confirmation of Non-Phase-Separated State>

In the IR spectrum measured by the IR microscope, whether an Si—O bond existed or not was checked to confirm whether a silicon oxide existed or not in a matrix in the surface layer. Moreover, measured points were observed using a scanning electron microscope (trade name: JSM-7800F; manufactured by JEOL Ltd.) under the conditions of an acceleration voltage of 5 kV and 10000 measurement magnifications to confirm whether a boundary between the urethane resin and the silicon oxide in the matrix existed or not. The surface layer in which the boundary between the urethane resin and the silicon oxide in the matrix was confirmed was evaluated as “Yes (Exists)” in terms of the phase-separated state, and the surface layer in which the boundary between the urethane resin and the silicon oxide in the matrix was not confirmed was evaluated as “No (Not exist)” in terms of the phase-separated state.

The evaluation results of each electro-conductive roller are shown in Table 13.

<Measurement of Nanoindenter Hardness>

The nanoindenter hardness was measured by the following measurement method. As a measurement instrument, a nanoindenter (Nanoindenter G200; manufactured by Keysight Technologies (former company name: Agilent Technologies)) was used to measure the hardness of the outermost surface of each electro-conductive roller. The measurement conditions are as follows.

Indenter: diamond tip;
Excitation frequency: 45 Hz;
Amplitude of excitation vibration: 2 nm;
Strain rate: 0.1/sec
Indentation depth: 400 nm; and
Measurement temperature: 23° C.

<Measurement of Surface Potential>

The surface potential of each electro-conductive roller was measured by the above-described method.

Obtained measurement results are shown in Table 13.

TABLE 13

| | | Polysilazane solution | | Urethane coating material | | | Phase | Nanoindenter | Surface |
|---|---|---|---|---|---|---|---|---|---|
| | | | Amount added | | Amount added | Si—N peak | separation | hardness | potential |
| | | Kind | [parts by mass] | Kind | [parts by mass] | Yes/No | Yes/No | [Gpa] | [V] |
| Examples | 1 | A-14 | 20 | B-1 | 100 | Yes | No | 4.8 | −5.2 |
| | 2 | A-14 | 20 | B-7 | 100 | Yes | No | 1.0 | −5.6 |
| | 3 | A-14 | 20 | B-8 | 100 | Yes | No | 4.7 | −7.3 |
| | 4 | A-13 | 20 | B-1 | 100 | Yes | No | 5.0 | −7.4 |
| | 5 | A-11 | 20 | B-1 | 100 | Yes | No | 4.7 | −6.9 |
| | 6 | A-12 | 20 | B-1 | 100 | Yes | No | 5.2 | −8.2 |
| | 7 | A-9 | 20 | B-1 | 100 | Yes | No | 5.3 | −7.6 |
| | 8 | A-14 | 10 | B-1 | 100 | Yes | No | 0.9 | −8.4 |
| | 9 | A-13 | 10 | B-1 | 100 | Yes | No | 0.9 | −7.8 |
| | 10 | A-11 | 10 | B-1 | 100 | Yes | No | 1.0 | −6.7 |
| | 11 | A-12 | 10 | B-1 | 100 | Yes | No | 1.0 | −8.9 |
| | 12 | A-9 | 10 | B-1 | 100 | Yes | No | 1.3 | −9.2 |
| | 13 | A-2 | 10 | B-1 | 100 | Yes | No | 1.4 | −9.2 |
| | 14 | A-3 | 10 | B-1 | 100 | Yes | No | 1.3 | −7.3 |
| | 15 | A-4 | 10 | B-1 | 100 | Yes | No | 1.0 | −7.5 |
| | 16 | A-5 | 10 | B-1 | 100 | Yes | No | 1.2 | −8.2 |
| | 17 | A-6 | 10 | B-1 | 100 | Yes | No | 1.0 | −8.1 |
| | 18 | A-7 | 10 | B-1 | 100 | Yes | No | 1.5 | −7.5 |
| | 19 | A-8 | 10 | B-1 | 100 | Yes | No | 1.1 | −7.5 |
| | 20 | A-1 | 10 | B-1 | 100 | Yes | No | 1.2 | −7.8 |
| | 21 | A-1 | 30 | B-1 | 100 | Yes | No | 9.3 | −8.3 |
| | 22 | A-1 | 25 | B-1 | 100 | Yes | No | 7.8 | −7.6 |
| | 23 | A-1 | 15 | B-1 | 100 | Yes | No | 2.1 | −9.3 |
| | 24 | A-1 | 10 | B-2 | 100 | Yes | No | 1.5 | −8.2 |
| | 25 | A-1 | 10 | B-3 | 100 | Yes | No | 1.0 | −7.9 |
| | 26 | A-1 | 10 | B-4 | 100 | Yes | No | 1.0 | −8.9 |
| | 27 | A-1 | 10 | B-5 | 100 | Yes | No | 1.0 | −9.2 |
| | 28 | A-1 | 10 | B-6 | 100 | Yes | No | 1.2 | −4.2 |
| | 29 | A-1 | 10 | B-7 | 100 | Yes | No | 1.1 | −5.3 |
| | 30 | A-14 | 50 | B-1 | 100 | Yes | No | 6.5 | −5.9 |
| | 31 | A-14 | 20 | B-1 | 100 | Yes | No | 4.9 | −6.2 |
| | 32 | A-1 | 10 | B-1 | 100 | Yes | No | 1.1 | −6.8 |

| Comparative | 1 | — | Yes | No | 5.0 | −50.7 |
|---|---|---|---|---|---|---|
| Examples | 2 | | Yes | No | 5.0 | −43.5 |
| | 3 | | No | No | 4.5 | −68.5 |
| | 4 | | No | No | 0.5 | −34.6 |
| | 5 | | No | No | 3.0 | −60.3 |
| | 6 | | No | No | 4.6 | −54.2 |

[5. Evaluation as Developing Roller]

Next, evaluation of the following items was conducted for the prepared electro-conductive rollers according to Examples 1 to 30 and Comparative Examples 1 to 5 as developing rollers.

<Evaluation Method of L/L Fogging>

Each electro-conductive roller was incorporated, as a developing roller, in a process cartridge (trade name: Toner Cartridge 323 Black; manufactured by Canon Inc.) of a laser printer (trade name LBP 7700C; manufactured by Canon Inc.). The process cartridge was left in an environment of a temperature of 15° C. and a humidity of 10% RH (hereinafter, referred to as L/L) for 24 hours or longer to conduct aging sufficiently. After the completion of leaving the cartridge in the environment, the process cartridge was loaded on the body of the laser printer to output 40000 sheets of images each having a printing rate of 0.1% under the same environment. After the completion of outputting the images, a white solid image was output.

A value of fogging was measured using the output white solid image. The value of fogging was defined as a value obtained by measuring the reflection density of transfer paper before forming the image and the reflection density of the transfer paper after forming the white solid image, and dividing the difference by the reflection density of the transfer paper before forming the image. The image-printed area on the transfer paper was divided into areas of 5 cm×5 cm sequentially from the upper left of the image-printed area to measure reflection density at the center of each area, and the reflection density of the transfer paper was defined as the minimum value among the obtained reflection densities. A reflection densitometer (trade name: TC-6DS/A, manufactured by Tokyo Denshoku Co., Ltd.) was used for measuring the reflection density.

Normally, a developer is hardly transferred on the transfer paper having a white solid image printed thereon and the fogging value is small. However, when image output is continuously conducted in the case where the electro-conductivity on the surface of a developing roller is not sufficient, the surface of the developing roller is excessively charged (hereinafter, also referred to as “charge-up”) due to the potential difference set between the developing roller and another member. The balance between the potential on the surface of the developing roller and the potential on the surface of the photosensitive member is lost due to the charge-up, and the developer moves onto the photosensitive member also during the formation of the white solid image and is further transferred on the transfer paper to cause fogging to occur. Accordingly, the fogging value can be used as an evaluation index of an extent of charge-up on the surface of a developing roller.

The evaluation for the developing rollers was conducted using the fogging value according to the following criteria. Evaluation results are shown in Table 14.

[Evaluation of L/L Fogging]

Rank A: fogging value less than 3.0%
Rank B: fogging value 3.0% or more and less than 4.0%
Rank C: fogging value 4.0% or more and less than 5.0%
Rank D: fogging value 5.0% or more
where,
the evaluation rank “A” means that “fogging” cannot be recognized visually on the image.
The evaluation rank “B” means that “fogging” can slightly be recognized visually on the image.
The evaluation rank “C” means that “fogging can be recognized visually on the image.
The evaluation rank “D” means that “fogging” can definitely be recognized visually on the image.

<Evaluation of Status of Occurrence of Filming>

Subsequently to the output of the white solid image, 2 sheets of half-tone images were output. Thereafter, the developing roller was taken out, and the developer on the surface was removed by air blowing to observe the surface of the developing roller. Specifically, the state of filming on the surface of the developing roller was observed using a digital microscope (trade name: VHX-600; manufactured by Keyence Corporation) at 1000 magnifications. Further, whether a defect due to filming, such as a streak, had occurred or not was visually observed for the obtained 2 sheets of half-tone images. The observation results were evaluated according to the following criteria to perform ranking. Results are shown in Table 14.

[Evaluation of Status of Occurrence of Filming]

Rank A: filming is not recognized on the surface of the electro-conductive roller, and a defect due to filming, such as a streak, cannot be confirmed on the images.
Rank B: minor filming is recognized on the surface of the electro-conductive roller. However, a defect due to filming, such as a streak, cannot be confirmed on the images.
Rank C: filming is recognized on the surface of the electro-conductive roller. Moreover, a defect due to filming, such as a streak, can be confirmed on the images.

<Evaluation of H/H Fogging>

Evaluation of H/H fogging was also conducted under the same conditions as in the evaluation of L/L fogging except an environment of a temperature of 30° C. and a relative humidity of 80% RH (hereinafter, referred to as “H/H”). Obtained results are shown in Table 14.

[Evaluation of H/H Fogging]

Rank A: fogging value less than 3.0%
Rank B: fogging value 3.0% or more and less than 4.0%
Rank C: fogging value 4.0% or more and less than 5.0%
Rank D: fogging value 5.0% or more

TABLE 14

| | L/L fogging | | | H/H fogging | |
|---|---|---|---|---|---|
| | Fogging | | Filming | Fogging | |
| | value [%] | Rank | Rank | value [%] | Rank |
| Example 1 | 0.6 | A | A | 0.3 | A |
| Example 2 | 0.7 | A | A | 0.3 | A |
| Example 3 | 0.7 | A | A | 0.4 | A |
| Example 4 | 0.9 | A | A | 1.2 | A |
| Example 5 | 1.3 | A | A | 1.5 | A |
| Example 6 | 1.2 | A | A | 1.4 | A |
| Example 7 | 1.5 | A | A | 1.8 | A |
| Example 8 | 2.1 | A | B | 1.8 | A |
| Example 9 | 2.2 | A | B | 1.4 | A |
| Example 10 | 2.5 | A | B | 1.6 | A |
| Example 11 | 2.4 | A | B | 1.5 | A |
| Example 12 | 2.3 | A | B | 1.9 | A |
| Example 13 | 2.8 | A | B | 2.4 | A |
| Example 14 | 2.9 | A | B | 2.3 | A |
| Example 15 | 2.5 | A | B | 2.2 | A |
| Example 16 | 2.6 | A | B | 2.4 | A |
| Example 17 | 2.7 | A | B | 2.3 | A |
| Example 18 | 2.5 | A | B | 2.9 | A |
| Example 19 | 3.6 | B | B | 2.8 | A |
| Example 20 | 2.7 | A | A | 2.5 | A |
| Example 21 | 2.2 | A | A | 3.2 | B |
| Example 22 | 2.8 | A | B | 2.9 | A |
| Example 23 | 2.9 | A | B | 3.3 | B |
| Example 24 | 2.5 | A | B | 3.2 | B |
| Example 25 | 2.5 | A | B | 3.1 | B |
| Example 26 | 2.6 | A | B | 3.5 | B |
| Example 27 | 2.5 | A | A | 2.8 | A |
| Example 28 | 2.7 | A | A | 2.9 | A |
| Example 29 | 2.7 | A | A | 2.8 | A |
| Example 30 | 0.8 | A | B | 0.6 | A |
| Comparative Example 1 | 5.9 | D | A | 5.2 | D |
| Comparative Example 2 | 5.6 | D | A | 4.5 | C |
| Comparative Example 3 | 5.1 | D | A | 4.9 | C |
| Comparative Example 4 | 6.1 | D | B | 5.5 | D |
| Comparative Example 5 | 5.5 | D | B | 5.2 | D |

Filming of the developing rollers according to Examples 1 to 30 was suppressed. Moreover, the developing rollers according to Examples 1 to 30 were able to suppress L/L fogging due to charge-up and H/H fogging caused by deficiency of the ability of imparting triboelectricity. On the contrary, the developing rollers according to Comparative Examples 1 to 5 had an effect in terms of suppressing filming, however L/L fogging occurred. It is considered to be a factor of the occurrence of L/L fogging that the surface of the developing rollers according to Comparative Examples 1 to 5 had insulation properties.

<Triboelectric Charge Quantity of Electro-Conductive Rollers>

Subsequently, the triboelectric charge quantity on the roller surface was measured for the electro-conductive rollers according to Examples 1 to 30.

After the developing rollers were left in an environment of a temperature of 35° C. and a relative humidity of 85% for 6 hours or longer, the measurement of the triboelectric charge quantity for the electro-conductive rollers was conducted under the same environment according to the following procedures.

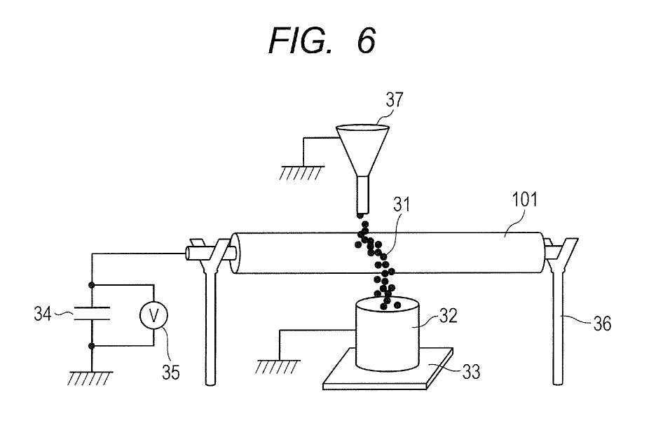

A cascade type surface electrostatic charge quantity measurement apparatus “TS-100AT” (trade name, manufactured by KYOCERA Chemical Corporation) illustrated in FIG. 6 was used for the measurement. As illustrated in FIG. 6, the electro-conductive roller 101 was set up on insulating support rods 36, a carrier 31 was put into a powder input opening 37 and dropped for 10 seconds to generate contact charge on the carrier 31. A standard carrier “N-01” (distributed by The Imaging Society of Japan) was used as the carrier 31. The total electrostatic charge quantity of the carrier 31 dropped in a saucer 32 set up on an insulating plate 33 was measured with a potentiometer 35 connected in parallel with a condenser 34 to determine the electrostatic charge quantity Q [μC]. Further, the mass M [g] of the carrier dropped in the saucer 32 was measured, and, from the values of Q and M, the electrostatic charge quantity per unit mass Q/M (μC/g) was calculated to determine the triboelectric charge quantity. Obtained results are shown in Table 15.

TABLE 15

| | Triboelectric |
|---|---|
| | charge quantity |
| Example | [μC/g] |
| Example 1 | −5.9 |
| Example 2 | −5.8 |
| Example 3 | −5.7 |
| Example 4 | −5.4 |
| Example 5 | −5.6 |
| Example 6 | −5.2 |
| Example 7 | −5.1 |
| Example 8 | −5.7 |
| Example 9 | −5.5 |
| Example 10 | −5.4 |
| Example 11 | −5.3 |
| Example 12 | −5.4 |
| Example 13 | −4.8 |
| Example 14 | −4.8 |
| Example 15 | −4.6 |
| Example 16 | −4.5 |
| Example 17 | −4.6 |
| Example 18 | −4.2 |
| Example 19 | −4.6 |
| Example 20 | −4.3 |
| Example 21 | −3.9 |
| Example 22 | −4.3 |
| Example 23 | −4.1 |
| Example 24 | −4.2 |
| Example 25 | −4.2 |
| Example 26 | −4.3 |
| Example 27 | −4.7 |
| Example 28 | −4.4 |
| Example 29 | −4.3 |
| Example 30 | −5.7 |

Fogging density is more suppressed as the triboelectric charge quantity of the electro-conductive roller is higher, namely as the ability of imparting triboelectricity of the developing roller is higher. From the results shown in Table 14 and Table 15, it can be said that the electro-conductive roller having an electro-conductive surface layer formed by using a polysilazane having an alkylamino group has a particularly superior ability of imparting triboelectricity and a high fogging density-suppressing effect in the case where the electro-conductive roller is used as a developing roller.

[6. Evaluation as Charging Rollers]

Evaluation of the following items was conducted for the electro-conductive rollers according to Examples 31 and 32, and Comparative Example 6 as charging rollers.

<Evaluation of Easiness of Occurrence of Filming on Surface>

The extent of occurrence of filming on the surface of the charging roller associated with the use of the charging roller was evaluated. In the case where filming occurs on the surface of the charging roller, density unevenness due to filming can occur in an electrophotographic image formed by using the charging roller. Thus, the electrophotographic image was visually observed to evaluate the extent of the density unevenness due to filming on the charging roller.

Specifically, the electro-conductive roller as an object of evaluation was incorporated in Toner Cartridge 323 Black (trade name, manufactured by Canon Inc.) as a charging roller. And the process cartridge was left in an environment of a temperature of 15° C. and a humidity of 10% RH for 24 hours or longer to conduct aging sufficiently. After the completion of leaving the cartridge in the environment, the process cartridge was installed on the body of an electrophotographic image forming apparatus (trade name: LBP 7700C; manufactured by Canon Inc.) to output 40000 sheets of images each having a printing rate of 0.1% under the same environment. And finally, 2 sheets of half-tone images were output. Evaluation in terms of defects due to filming, such as a streak and a spot, was conducted according to the following criteria by visually observing the obtained two half-tone images. Obtained results are shown in Table 16.

A: a streak or spot does not exist.
B: a streak or spots exist over a width of 2 cm.
C: a streak or spots exist over a width of 5 cm.
D: a streak or spots exist over the whole surface.

TABLE 16

| | Density unevenness |
|---|---|
| | evaluation rank |
| Example 31 | A |
| Example 32 | A |
| Comparative Example 6 | D |

Favorable images in which the density unevenness due to filming had not occurred were able to be obtained for the charging rollers according to Examples 31 and 32. On the contrary, the density unevenness occurred in images formed with the charging roller according to Comparative Example 6. It is considered to be a factor of the occurrence of the density unevenness that the toner remaining after transfer was electrostatically attracted to the surface of the charging roller due to charge-up of the charging roller to become liable to adhere to the surface of the charging roller.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-119285, filed Jun. 12, 2015, which is hereby incorporated by reference herein in its entirety.

What is claimed is:

1. An electro-conductive member for electrophotography, comprising:
an electro-conductive substrate;
an elastic layer on the substrate; and
an electro-conductive surface layer covering a surface of the elastic layer,
wherein the electro-conductive surface layer comprises a matrix in which a urethane resin and a silicon oxide exist in a non-phase-separated state, and
the matrix has a peak of a Si—N bond derived from a polysilazane in a wavelength region from 800 cm⁻¹ or higher and 950 cm⁻¹ or lower in an infrared absorption spectrum of the matrix.

2. The electro-conductive member according to claim 1,
wherein the electro-conductive surface layer comprises a silicon oxide obtained from a polysilazane, the polysilazane having a structural unit represented by the following formula (1): 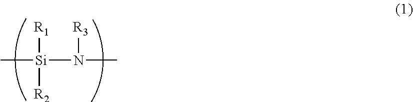
wherein R₁ to R₃ each independently represent any one selected from the group consisting of a hydrogen atom, an alkyl group, an alkylamino group and an alkoxy group, with proviso that a case in which all of R₁ to R₃ are hydrogen atoms is excluded.

3. The electro-conductive member according to claim 2, wherein in the formula (1), at least one of R₁ to R₃ is the alkylamino group.

4. The electro-conductive member according to claim 1, wherein the surface of the electro-conductive member has a nanoindenter hardness of 0.8 GPa or higher and 10.0 GPa or lower.

5. The electro-conductive member according to claim 1, wherein the urethane resin is obtained from a urethane coating material having an isocyanate index from 1.5 or more and 5.0 or less.

6. The electro-conductive member according to claim 1, wherein the electro-conductive surface layer comprises carbon black.

7. The electro-conductive member according to claim 1, wherein the electro-conductive surface layer has a thickness of 1 μm or more and 100 μm or less.

8. The electro-conductive member according to claim 1, wherein the electro-conductive member is a developing member.

9. The electro-conductive member according to claim 1, wherein the electro-conductive member is a charging member.

10. A process cartridge configured to be detachably attachable to a body of an electrophotographic apparatus, the process cartridge comprising an electro-conductive member for electrophotography as at least one selected from the group consisting of a charging member and a developing member,
wherein the electro-conductive member is an electro-conductive member for electrophotography comprising: an electro-conductive substrate; an elastic layer on the substrate; and an electro-conductive surface layer covering a surface of the elastic layer,
wherein the electro-conductive surface layer comprises a matrix in which a urethane resin and a silicon oxide exist in a non-phase-separated state, and
the matrix has a peak of a Si—N bond derived from a polysilazane in a wavelength region from 800 cm⁻¹ or higher and 950 cm⁻¹ or lower in an infrared absorption spectrum of the matrix.

11. An electrophotographic apparatus comprising an electro-conductive member for electrophotography as at least one selected from the group consisting of a charging member and a developing member,
wherein the electro-conductive member is an electro-conductive member for electrophotography comprising: an electro-conductive substrate; an elastic layer on the substrate; and an electro-conductive surface layer covering a surface of the elastic layer,
wherein the electro-conductive surface layer comprises a matrix in which a urethane resin and a silicon oxide exist in a non-phase-separated state, and
the matrix has a peak of a Si—N bond derived from a polysilazane in a wavelength region from 800 cm⁻¹ or higher and 950 cm⁻¹ or lower in an infrared absorption spectrum of the matrix.
